(19) United States
(12) Patent Application Publication
(10) Pub. No.: US 2010/0130673 A1
(43) Pub. Date: May 27, 2010

(54) HEAT-DISSIPATING SILICONE GREASE COMPOSITION

(75) Inventors: Kazutoshi ITO, Aichi (JP); Hiroaki Kizaki, Gunma (JP); Kunihiro Yamada, Gunma (JP); Osamu Uchida, Gunma (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: SHIN-ETSU CHEMICAL CO., LTD., Tokyo (JP)

(21) Appl. No.: 12/624,558

(22) Filed: Nov. 24, 2009

(30) Foreign Application Priority Data
Nov. 26, 2008 (JP) 2008-300437

(51) Int. Cl. C08L 83/04

(52) U.S. Cl. 524/588

(57) ABSTRACT

An invention of a heat-dissipating grease composition characterized by comprising of the following components (A)-(C) is disclosed.
Component (A): 100 mass parts of organopolysiloxane wherein a thixotropicity degree α is 1.03-1.50, a viscosity is 100-1,000,000 mPa·s at 25° C.; in this regard, the thixotropicity degree α is η₁/η₂. Herein, η₁ is a measured viscosity at 25° C. measured by a B type rotation viscometer at 6 rpm of a rotor, η₂ is a measured viscosity at 25° C. measured by a B type rotation viscometer at 12 rpm of the rotor.
Component (B): 5-200 mass parts of hydrolysable organopolysiloxane having three functional groups at one end represented by the following general formula (1);

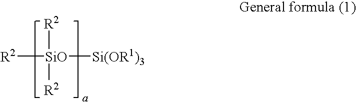

R¹ in the formula is an alkyl group having 1-6 carbon atoms, R² is at least one kind of groups having 1-18 carbon atoms selected from a group consisting of substituted or unsubstituted monovalent hydrocarbon groups, a is an integer of 5-120.
Component (C): 200-4,000 mass parts of a thermoconductive inorganic filler having an average particle diameter of 0.1-100 μm and 0.01-50 m²/g of a specific surface.

### FIELD OF THE INVENTION

This invention relates to a heat-dissipating grease composition, and in particular to a heat-dissipating silicone grease composition wherein not only voids and cracks but also a shearing and oil bleeds do not occur and heat-dissipating properties do not decline even though it is exposed to a high temperature over a long period of time.

### BACKGROUND OF THE INVENTION

Since most electronic parts generate heat when they are used, it is necessary to remove heat from them in order to work them properly.

Heat-dissipating silicone greases based on silicone grease and containing various kinds of powders as fillers, are known in the prior art (Patent documents 1-8).
[Patent document 1]

Japanese Patent Publication Tokko-sho 52-33272
[Patent document 2]

Japanese Patent Publication Tokko-sho 59-52195
[Patent document 3]

Japanese Unexamined Patent Publication Tokkai-sho 52-125506
[Patent document 4]

Japanese Unexamined Patent Publication Tokkai-sho 57-36302
[Patent document 5]

Japanese Unexamined Patent Publication Tokkai-sho 62-43492
[Patent document 6]

Japanese Unexamined Patent Publication Tokkai-hei 2-212556
[Patent document 7]

Japanese Unexamined Patent Publication Tokkai-hei 3-162493
[Patent document 8]

Japanese Unexamined Patent Publication Tokkai 2003-301189

However, there was a disadvantage where heat-dissipating properties declined since the occurrence of voids and cracks makes it impossible to remove heat efficiently when used over a long period of time. Furthermore, a shearing and oil bleeds of heat-dissipating grease sometimes occur when used. In this case, heat-dissipating properties decline as well.

As a result of intensive studies aimed at solving the above problem, the inventors found that voids and cracks in the silicone grease cannot occur easily even though it is exposed to a high temperature over a long period of time when a specific organopolysiloxane (A) having a certain range of thixotropicity degree and a specific hydrolysable organopolysiloxane (B) are used as a base oil, and at the same time a thermoconductive filler (C) having a certain average particle diameter and a certain specific surface is used to prepare the silicone grease; and a shearing and oil bleeds which tend to occur when the silicone grease is used as a heat-dissipating silicone grease can be prevented when the proportion of the surface area of the above filler (C) and the mass part used of the above hydrolysable organopolysiloxane (B) is within a certain definite range, and thereby arrived at this invention.

### DISCLOSURE OF INVENTION

### Problems to be Solved by the Invention

It is therefore the object of this invention to provide a highly reliable heat-dissipating silicone grease composition which can show its stable thermoconductive performance over a long period of time.

### Means to Solve the Problems

Namely, the present invention is a heat-dissipating grease composition characterized by comprising of the following components (A)-(C).
Component (A): 100 mass parts of organopolysiloxane wherein a thixotropicity degree α is 1.03-1.50, a viscosity is 100-1,000,000 mPa·s at 25° C.; wherein the thixotropicity degree α is η₁/η₂. Herein, η₁ is the measured viscosity at 25° C. measured by a B type rotation viscometer at 6 rpm of the rotor, η₂ is the measured viscosity at 25° C. measured by a B type rotation viscometer at 12 rpm of the rotor.
Component (B): 5-200 mass parts of hydrolysable organopolysiloxane having three functional groups at one end represented by the following general formula (1);

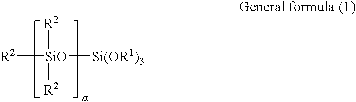

R¹ in the formula is an alkyl group having 1-6 carbon atoms, R² is at least one kind of groups having 1-18 carbon atoms selected from a group consisting of substituted or unsubstituted monovalent hydrocarbon groups, a is an integer of 5-120.
Component (C): 200-4,000 mass parts of a thermoconductive inorganic filler having an average particle diameter of 0.1-100 μm and 0.01-50 m² /g of a surface area.

It is preferable in the present invention that the organopolysiloxane of the above component (A) is the organopolysiloxane obtained by reacting an organopolysiloxane having at least two alkenyl groups directly bonded to silicon atoms within a molecule with a specific organhydrogenpolysiloxane having at least two Si—H groups within a molecule. It is more preferable that the organopolysiloxane of the above component (A) is the organopolysiloxane containing [R⁴SiO_{3/2}] unit and/or [SiO_{4/2}] unit together with [R⁴₃SiO_{1/2}] unit and [R⁴₂SiO] unit.

In addition, it is preferable to use each component in order that a value of a thermoconductive inorganic filler of the above component (C), which is calculated by dividing the surface area represented by [specific area×mass of component (C)] with mass of hydrolysable organopolysiloxane of the above component (B), is within the range of 10-500 m²/g.

### Effects of the Invention

The heat-dissipating grease composition of the present invention can show stable thermoconductive performance over a long period of time since voids and cracks do not occur and furthermore a shearing of grease and oil bleeds can be prevented even though it is used at a high temperature over a long period of time.

### WORKING EMBODIMENT OF THE INVENTION

The organopolysiloxane of component (A) composing the heat-dissipating silicone grease composition of the present invention has thixotropic properties. It is known that the thixotropic properties of oil are expressed by the thixotropicity degree α, and that the viscosity of the oil is larger when the larger α is. In the present invention, the thixotropicity degree of the organopolysiloxane must lie within the range 1.03-1.50, but preferably 1.05-1.45. 1.11-1.40 is the most preferable. If the thixotropicity degree of the organopolysiloxane is less than 1.03, the viscosity of the organopolysiloxane is low, then the affinity of this organopolysiloxane to the thermoconductive filler is weak, and the silicone grease composition tends to cause oil bleed. On the other hand, greasy finish cannot be obtained since it is difficult to mix component (B) and/or component (C) if the thixotropicity degree of the organopolysiloxane is larger than 1.50.

The viscosity at 25° C. of the organopolysiloxane of component (A) used in the present invention must lie within the range of 100-1,000,000 mPa·s, in particular 1000-100,000 mPa·s is preferable. If it is less than 100 mPa·s, the stability of the silicone grease composition obtained is poor, and if it is larger than 1,000,000 m Pa·s, it is difficult to mix the organopolysiloxane of component (A) with the component (B) and/or component (C).

The organopolysiloxane of the above component (A) can be easily obtained, for example, by an addition reaction between an organopolysiloxane having at least two alkenyl groups directly bonded to silicon atoms within a molecule, and a organohydrogenpolysiloxane having at least two SiH groups within a molecule represented by the following general formula (2), in the presence of platinum compounds of catalyst such as platinum itself, chloroplatinic acid, a platinum-olefin complex and a platinum-alcohol complex.

The organopolysiloxane having at least two alkenyl groups directly bonded to the above silicon atoms within a molecule may be straight chain or branched. It may also be a mixture of two or more types having different viscosities. The alkenyl group may be vinyl, allyl, 1-butenyl or 1-hexenyl, etc., but it is preferably vinyl from the viewpoints of ease of synthesis and cost. The alkenyl groups combined with silicon atoms may be at the end of or in the middle of the molecular chain of organopolysiloxane, but it is preferable that they are only at both ends of the molecular chain from the viewpoint of flexibility as organopolysiloxane.

Examples of organic groups other than an alkenyl group, which are combined with silicon atoms in the organopolysiloxane having at least two alkenyl groups directly bonded to the above silicon atoms within a molecule are alkyl groups such as methyl, ethyl, propyl, butyl, hexyl and dodecyl; an aryl group such as phenyl; aralkyl groups such as 2-phenyl ethyl and 2-phenyl propyl; and substituted hydrocarbon groups such as chloromethyl or 3,3,3-trifluropropyl. It is preferable in the present invention that methyl groups are 90 mol % or more from the viewpoints of ease of synthesis and cost among these.

It is preferable that the organopolysiloxane of the above component (A) is the organopolysiloxane obtained by reacting the organopolysiloxane having at least two alkenyl groups directly bonded to silicon atoms within a molecule with the specific organohydrogenpolysiloxane having at least two Si—H groups within a molecule represented by the following general formula (2).

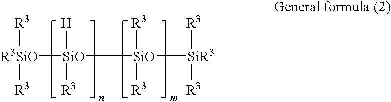

R³ in the general formula (2) is a hydrogen atom, or at least one kind of groups having 1-20 carbon atoms selected from a group consisting of substituted or unsubstituted monovalent hydrocarbon groups except for unsaturated hydrocarbon groups. n and m are respectively numbers which lie within the ranges 1≦n≦1,000 and 0≦m≦1,000.

Examples of the above R³ are alkyl groups such as methyl, ethyl, propyl, hexyl, octyl, decyl, dodecyl, tetradecyl, hexadecyl, and octadecyl; cycloalkyl groups such as cyclopentyl and cyclohexyl; aryl groups such as phenyl and tolyl; aralkyl groups such as 2-phenylethyl and 2-methyl-2-phenylethyl; and halogenated hydrocarbon groups such as 3,3,3-trifluoropropyl, 2-(perfluorobutyl)ethyl, 2-(perfluoro octyl)ethyl and p-chlorophenyl. It is preferable that 90 mol % or more of R³ are methyl groups from the viewpoint of ease of synthesis and cost.

To obtain the intended organopolysiloxane of component (A) by the above addition reaction, two or more kinds of organopolysiloxane having alkenyl groups and/or organopolysiloxane having Si—H groups, may be used respectively. A dimethylpolysiloxane having no reactive group may also be mixed.

As another method to obtain the organopolysiloxane of component (A), a method introducing a [R⁴SiO_{3/2}] unit and/or [SiO_{4/2}] unit, which are structural units of common linear organopolysiloxanes, together with the [R⁴₃SiO_{1/2}] unit and [R⁴₂SiO] unit is exemplified. Herein, R⁴ is identical group to the above R³. As the concrete method of manufacturing these organopolysiloxanes, the following examples are referred to;
(1) (CH₃)₃SiCl, (CH₃)₂SiCl₂, (CH₃)SiCl₃ etc. are hydrolyzed and condensed.
(2) This condensate may be reacted with a cyclic low-molecular siloxane at room temperature or with heating in the presence of a catalyst selected from hydroxides such as an alkali metal hydroxide, alkali metal silanolate or tetra-alkylphosphonium hydroxide and tetraalkylammonium hydroxide, or strong acids such as sulfuric acid or organic sulfonic acid.
(3) Alternatively, an organopolysiloxane consisting of a (CH₃)₃SiO_{1/2} unit and SiO₂ unit, having a hydroxyl group, is reacted with a polydiorganosiloxane having a silanol group at room temperature or with heating in the presence of a condensation catalyst, such as an amine catalyst or tin catalyst.

The synthesizing method of component (A) used in the present invention is not limited by the above examples. It may be chosen from any synthetic method as long as the defined thixotropicity degree is obtained.

The hydrolysable organopolysiloxane having three functional groups at one end of a molecule, which is used as Component (B) in the present invention, is used for treating the surface of thermoconductive inorganic filler of component (C). This hydrolysable organopolysiloxane, having three functional groups at one end of a molecule, not only helps to fill the thermoconductive inorganic filler powder highly in the present silicone grease composition, but also helps to prevent an aggregation among powders by covering the surfaces of these powders. In addition, it has a function that improves the heat resistance performance of the silicone grease composition of the present invention since the above effect lasts at a high temperature. The hydrolysable organopolysiloxane of Component (B) is represented by the following general formula (1).

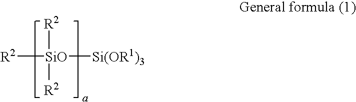

In the above general formula (1), examples of R¹ are alkyl groups having 1-6 carbon atoms such as methyl, ethyl and propyl. It is preferable in the present invention in particular that it is methyl or ethyl group. On the other hand, R² is at least one kind of groups having 1-18 carbon atoms selected from substituted or unsubstituted monovalent hydrocarbon groups. Examples of these groups are alkyl groups such as methyl, ethyl, propyl, hexyl, octyl, decyl, dodecyl, tetradecyl, hexadecyl and octadecyl; cycloalkyl groups such as cyclopentyl and cyclohexyl; alkenyl groups such as vinyl and allyl; aryl groups such as phenyl and tolyl; aralkyl groups such as 2-phenylethyl and 2-methyl-2-phenylethyl; and halogenated hydrocarbon groups such as 3,3,3-trifluoropropyl, 2-(perfluorobutyl)ethyl, 2-(perfluoro octyl)ethyl and p-chlorophenyl. The methyl group is preferable in the present invention in particular.

“a” in the above general formula (1) is an integer of 5-120, but 10-90 is preferable. The quantity added of the above hydrolysable organopolysiloxane having three functional groups at one end of the molecule must lie within the range of 5-200 mass parts, but 10-150 mass parts are preferable. If the addition amount is less than 5 mass parts, the effect of helping to fill the thermoconductive inorganic filler powder highly resulted from covering the surfaces of these powders, which prevents aggregation among powders, namely, the effect of improving the heat resistance performance by the effect of high filling cannot be obtained. On the contrary, if it is beyond 200 mass parts, surplus oil separates.

The thermoconductive inorganic filler of component (C) gives thermal conductivity to the heat-dissipating silicone grease composition of the present invention. The average particle diameter of the thermoconductive inorganic filler must lie within 0.1-100 μm, but 0.5-50 μm is preferable. If the average particle diameter is less than 0.1 μm, the viscosity of the composition obtained is too high and it has poor extensibility, whereas if it is larger than 100 micrometers, the composition obtained is uneven. In this regard, the above average particle diameter is a volume accumulation average particle diameter measured by the laser diffraction scattering particle size distribution measuring device (Microtrac MT-3000: commercial name manufactured by NIKKISO Co., Ltd).

The specific surface of the thermoconductive inorganic filler of component (C) must lie within 0.01-50 m²/g in the present invention. 0.1-30 m²/g is preferable. If the specific surface is less than 0.01 m²/g, the composition obtained is uneven. If it is larger than 50 m²/g, voids and cracks occur during exposure to a high temperature, which is not preferable. In this regard, the above specific surface is a value measured by the fully automatic BET type specific surface measuring device (Macsorb HM-1200: commercial name manufactured by NIKKISO Co., Ltd).

The blending amount of the thermoconductive inorganic filler must lie within 200-4000 mass parts, but 400-3000 mass parts is preferable. If the blending amount is less than 200 mass parts, the thermal conductivity of the composition obtained is poor and storage stability is poor, whereas if it exceeds 4,000 mass parts, it has poor extensibility, which does not make the composition greasy.

The thermoconductive inorganic filler used in the present invention is not limited in particular as long as it has high thermal conductivity. Specific examples are aluminum powder, zinc oxide powder, alumina powder, boron nitride powder, aluminum nitride powder, silicon nitride powder, copper powder, silver powder, diamond powder, nickel powder, zinc powder, stainless steel powder and carbon powder. These particles may be a spherical or irregular shape, and two or more kinds thereof may be used in combination.

In addition, it is preferable in the present invention that a value of a thermoconductive inorganic filler of the above component (C), which is calculated by dividing the surface area represented by [specific area×mass of component (C)] with mass of hydrolysable organopolysiloxane of the component (B), having three functional groups at one end of a molecule, is within the range of 10-500 m²/g (hereinafter, described as “C surface area/B”), in particular 20-300 m²/g is more preferable. If C surface area/B is under 10 m²/g, component (B) is too much against component (C). This excess of component (B) causes a shearing and oil bleeds of heat-dissipating grease. If C surface area/B is beyond 500 m²/g, component (B) is not sufficient against component (C) and it is difficult to fill component (C) highly. As a result, not only the effect of improving heat resistance of the heat-dissipating grease is poor, but also the composition is not greasy and voids and cracks occur during exposure to a high temperature.

In order to manufacture the heat-dissipating silicone grease composition of the present invention, component (A), component (B) and component (C) are mixed by mixers such as a Trimix, Twinmix, Planetary Mixer (registered trademarks of Inoue Seisakusyo K.K.), an Ultramixer (registered trademark of Mizuho Kogyo K.K.), and a Hivis Supermix (registered trademark of Tokushukika Kogyo K.K.). The mixture may be heated to 50-150° C. if required.

Further, when obtaining intended heat-dissipating silicone grease composition by using the above organopolysiloxane having at least two alkenyl groups within a molecule and an organohydrogenpolysiloxane having at least two Si—H groups represented by general formula (2), all the manufacturing process can be simplified by pre-stir and mixing component (B) and component (C) with the organopolysiloxane having at least two alkenyl groups within a molecule and the organohydrogenpolysiloxane having at least two Si—H groups represented by before mentioned general formula (2), and then adding further a platinum compound, etc. in the mixture to carry out the addition reaction.

In this regard, after mixing each component as above-mentioned, it is preferable to perform a kneading operation under a high shearing force to obtain a uniform finish. The kneading apparatus used in this case may be a three roller type, colloid mill, sand grinder, etc., but the three roller type is preferable in particular.

The heat-dissipating silicone grease composition of the present invention obtained as described above does not cause voids and cracks even though it is used at a high temperature over a long period of time, and can prevent a shearing of grease and oil bleeds which are problems during using. Therefore, it has stable thermoconductive properties over a long period of time.

Hereafter, this invention will be further described referring to the examples, but the present invention should not be limited thereby.

The viscosity of the compound obtained was the viscosity measured at 25° C. by B type rotation viscometer manufactured by TOKYO KEIKI INC.

### Synthesis Example 1

### Synthesis of Organopolysiloxane A-1 of Component (A)

500 g of an organopolysiloxane capped at both ends by a dimethylvinylsilyl group, wherein 5 mol % of the main chain is phenyl groups and the remaining 95 mol % is methyl groups, and a viscosity at 25° C. is 700 mPa·s, 3.0 g of the hydrogen organopolysiloxane represented by the following formula (3) and 5.0 g of the organohydrogenpolysiloxane represented by the following formula (4), were introduced into a flask having an internal volume of 1,000 ml fitted with a stirrer, thermometer, condenser tube and nitrogen gas inlet pipe.

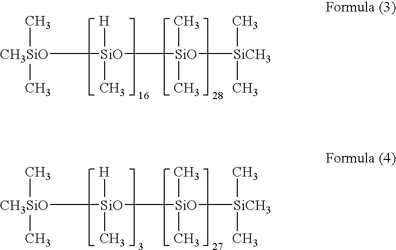

Next, 0.25 g of platinum catalyst composed of dimethylpolysiloxane solution of a platinum-divinyl tetramethyldisiloxane complex (containing 1 mass % of platinum atom) was introduced, and mixed with stirring at 120° C. for 1 hour to obtain an organopolysiloxane A-1. When the viscosity of A-1 was measured, the following values were obtained.

### Viscosimetry Results:

26,000 mPa·s (rotor No. 4/6 rpm).
22,500 mPa·s (rotor No. 4/12 rpm)
   From a calculation based on the above results, the thixotropicity degree α of 1.16 was obtained.

### Synthesis of Base Oil X

3,000 g of water was introduced into a flask having an internal volume of 5 liters fitted with a stirrer, thermometer, condenser tube and dropping apparatus, and a mixture of 490 g of trimethylchlorosilane, 560 g of dimethyldichlorosilane and 650 g of methyltrichlorosilane were dripped in the water under stirring for 3 hours while cooling the flask so that the temperature of the reaction liquid was 50° C. or less. After stirring at 30° C. for a further 2 hours, the aqueous layer (hydrochloric acid and water) was separated, 1,700 g of a 3% aqueous sodium carbonate solution was added to the organic layer, and the mixture was stirred at room temperature for 2 hours. The aqueous layer was separated and removed, 70 g of anhydrous sodium sulfate was added to the remaining organic layer, and after stirring at room temperature for 3 hours, this was filtered to obtain a transparent, colorless base oil X having a viscosity of 14 mPa·s.

### Synthesis Example 2

### Synthesis of Organopolysiloxane A-2 of Component (A)

10 g of the obtained base oil X, 22 g of trimethylsilyl end-capped polydimethylsiloxane having a viscosity of 10 mPa·s and 300 g of octamethyl cyclotetrasiloxane were introduced into a flask having an internal volume of 500 ml fitted with a stirrer, a thermometer, condenser tube and nitrogen gas inlet tube, and the mixture was heated to 120° C. while passing nitrogen gas. Next, 0.3 g of potassium hydroxide was added, the temperature was raised to 150° C., and after stirring for 4 hours, the solution was cooled to 100° C. 2 g of ethylene chlorohydrin was added, unreacted low polymer siloxane was removed, and an organopolysiloxane A-2 was thus obtained.

When the viscosity of A-2 was measured, the following values were obtained.

### Viscosimetry Results:

36,000 mPa·s (rotor No. 4/6 rpm)
27,300 mPa·s (rotor No. 4/12 rpm)

From a calculation based on the above results, the thixotropicity degree α of 1.32 was obtained.

### Synthesis Example 3

### Synthesis of Organopolysiloxane A-3 of Component (A)

An organopolysiloxane A-3 was obtained in an identical way to that of Synthesis Example 2 except that 25 g of base oil X, which is used in the Synthesis Example 2, and 308 g of octamethylcyclotetrasiloxane were used. When this viscosity was measured, the following values were obtained.

### Viscosimetry Results:

2,200 mPa·s (rotor No. 2/6 rpm),
2,100 mPa·s (rotor No. 2/12 rpm)
   From a calculation based on the above results, the thixotropicity degree α of 1.05 was obtained.

### Synthesis Example 4

### Synthesis of Organopolysiloxane A-4 of Component (A)

An organopolysiloxane A-4 was obtained in an identical way to that of Synthesis Example 1, except that 500 g of dimethylpolysiloxane capped at both ends by dimethylvinylsilyl groups and having a viscosity at 25° C. of 600 mPa·s was used instead of the organopolysiloxane having 700 mPa·s of a viscosity at 25° C. used in the Synthesis Example 1, together with 23 g of an organohydrogenpolysiloxane represented by the above formula (4) and 33 g of organohydrogenpolysiloxane represented by the following formula (5).

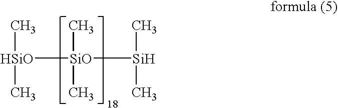

When the viscosity of A-4 was measured, the following values were obtained.

### Viscosimetry Result:

72,000 mPa·s (rotor No. 4/6 rpm),
46,000 mPa·s (rotor No. 4/12 rpm)
   From a calculation based on the above results, the thixotropicity degree α of 1.57 was obtained.

### Synthesis Example 5

### Synthesis of Organopolysiloxane A-5 of Component (A)

An organopolysiloxane A-5 was obtained in an identical way to that of

Synthesis Example 2, except that 100 g of base oil X, which was used in the Synthesis Example 2, and 200 g of octamethylcyclotetrasiloxane were used. When the viscosity of A-5 was measured, the following values were obtained,

### Viscosimetry Result:

450 mPa·s (rotor No. 1/6 rpm),
440 mPa·s (rotor No. 1/12 rpm)
   From a calculation based on the above results, the thixotropicity degree α of 1.02 was obtained.

A dimethylpolysiloxane (KF-96 H10, 000cs: commercial name manufactured by Shin-Etsu Chemical co. Ltd.) represented by the following formula (6) as A-6 of component (A) was used.

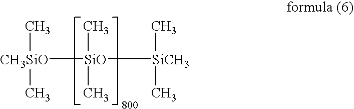

The viscosimetry result of A-6 is as follows:

### Viscosimetry Result:

9800 mPa·s (rotor No. 3/6 rpm),
9700 mPa·s (rotor No. 3/12 rpm)
   From a calculation based on the above results, the thixotropicity degree α of 1.01 was obtained.

### Example and Comparative Example

The above organopolysiloxanes A-1˜A-6, and the following components (B) and (C) were mixed at 120° C. for 1 hour using a planetary mixer (manufactured by Inoue Seisakusyo K.K.), and the heat-dissipating silicone compositions were manufactured.

### B-1: Hydrolysable Organopolysiloxane Represented by the Following Composition Formula

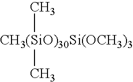 [0082] C-1: Alumina powder (average particle diameter 10 μm, specific surface 1.5 m²/g)
C-2: Alumina powder (average particle diameter 1 μm, specific surface 8 m²/g)
C-3: Zinc oxide powder (average particle diameter 0.3 μm, specific surface 4 m²/g)
C-4: Aluminum powder (average particle diameter 10 μm, specific surface 3 m²/g)
C-5: Alumina powder (average particle diameter 0.01 μm, specific surface 160 m²/g)
   The following physical properties were measured and evaluated concerning the obtained heat-dissipating silicone grease compositions. Component ratios and evaluation results of each example and comparative example were shown in Tables 1 and 2.

### 1. A Test Concerning the Inhibiting Effect of Voids and Cracks

1 g of silicone grease composition together with a 1 mm thick spacer was put between two slide glasses (namely, the silicone grease composition which was 1 mm thick.). The sample was left horizontally in the oven at 150° C. for 1,000 hours. After being left for 1,000 hours, the conditions of the silicone grease composition were observed visually and evaluated as follows:
◯: No voids or no cracks.
×: Some voids or cracks occurred.

### 2. A Test Concerning the Inhibiting Effect of Shearing

The same sample as that of the above void-crack test was placed vertically in the small sized cold thermal impact tester TSE-11A (manufactured by ESPEC CORP.) and the heat balance cycle from −40° C./30 minutes→+125° C./30 minutes to −40° C./30 minutes was performed 100 times. The conditions of the silicone grease composition were observed visually and evaluated as follows:
◯: No shearing from the initial position.
×: Some shearing from the initial position

### 3. Thermal Conductivity

Thermal conductivity at 25° C. was measured by using Quick Thermal Conductivity Meter QTM-500 (manufactured by KYOTO ELECTRONICS MANUFACTURING CO. LTD.).

TABLE 1

| | Example | | | | | |
|---|---|---|---|---|---|---|
| Component | 1 | 2 | 3 | 4 | 5 | 6 |

| | | | | | | | | |
|---|---|---|---|---|---|---|---|---|
| Blend | Blend (A) | A-1 | 100 | | | 100 | 100 | 100 |
| (g) | | A-2 | | 100 | | | | |
| | | A-3 | | | 100 | | | |
| | Blend (B) | B-1 | 100 | 100 | 100 | 200 | 20 | 100 |
| | Blend (C) | C-1 | 3000 | 3000 | 3000 | | | |
| | | C-2 | | | | 2000 | | |
| | | C-3 | | | | | 500 | 500 |
| | | C-4 | | | | | | 1500 |

| C Surface Area/B (m²/g) | | 45 | 45 | 45 | 80 | 100 | 95 |
|---|---|---|---|---|---|---|---|
| Void.crack test | After 1000 hours | ◯ | ◯ | ◯ | ◯ | ◯ | ◯ |
| Shearing test | After 100 times | ◯ | ◯ | ◯ | ◯ | ◯ | ◯ |

| | | | | | | |
|---|---|---|---|---|---|---|
| Thermal conductivity (W/m ° C.) | 3.4 | 3.2 | 3.3 | 1.5 | 1.2 | 4.1 |

TABLE 2

| | | | Comparative Example | | | | | | | |
|---|---|---|---|---|---|---|---|---|---|---|
| | | Component | 1 | 2 | 3 | 4 | 5 | 6 | 7 | 8 |
| Blend | Blend (A) | A-1 | | | | 100 | 100 | 100 | 100 | 100 |
| (g) | | A-4 | 100 | | | | | | | |
| | | A-5 | | 100 | | | | | | |
| | | A-6 | | | 100 | | | | | |
| | Blend (B) | B-1 | 100 | 100 | 100 | 2 | 300 | 100 | 100 | 200 |
| | Blend (C) | C-1 | 3000 | 3000 | 3000 | | | 100 | 5000 | |
| | | C-3 | | | | 500 | 500 | | | |
| | | C-5 | | | | | | | | 2000 |

| C Surface Area/B (m²/g) | | 45 | 45 | 45 | 1000 | 6.7 | 1.5 | 75 | 1600 |
|---|---|---|---|---|---|---|---|---|---|
| Void.crack test | after | non-greasy | X | X | X | ◯ | ◯ | non-greasy | X |
| | 1000 hours | | oil blead | oil blead | | oil blead | oil blead | | |
| Shearing test | after 100 times | — | X | X | ◯ | X | X | — | ◯ |

| | | | | | | | | |
|---|---|---|---|---|---|---|---|---|
| Thermal conductivity | — | 3.4 | 3.3 | 1.1 | 1.1 | 0.2 | — | 1.4 |
| (W/m ° C.) | | | | | | | | |

As is clear from Table 1, it was confirmed that the heat-dissipating silicone grease composition of the present invention causes neither voids nor cracks, and is excellent in preventing shearing and has an excellent physical properties.

It was confirmed from the results of Comparative Example 1 that it is difficult to manufacture the grease if the thixotropicity degree of component (A) is higher than the range of the present invention. On the contrary, it was confirmed from the results of Comparative Examples 2 and 3 that it is easy to cause voids and cracks, or the prevention of shearing declines if the thixotropicity degree of component (A) is lower than the range of the present invention.

It was confirmed from the results of Comparative Example 4 that it is easy to cause voids and cracks if the blending ratio of component (B) is lower than the range of the present invention. On the contrary, it was confirmed from the results of Comparative Example 5 that voids etc. does not occur, but oil bleeds cause and the prevention of shearing declines, if the blending ratio of component (B) is higher than the range of the present invention.

It was confirmed from the results of Comparative Example 6 that oil bleeds occur and the prevention of shearing declines if the blending ratio of component (C) is lower than the range of the present invention. On the contrary, it was confirmed from the results of Comparative Example 7 that it is difficult to manufacture the grease if the blending ratio of component (C) is higher than the range of the present invention.

In addition, it was confirmed from the results of Comparative Example 8 that it is easy to cause voids and cracks if the average particle diameter of component (C) is larger than the range of the present invention and the specific surface is larger than the range of the present invention.

### INDUSTRIAL APPLICABILITY

The heat-dissipating silicone grease composition of the present invention is extremely useful for performing electronic parts suitably over a long period of time since heat-dissipating properties do not decline even though it is exposed to a high temperature over a long period of time.

1. A heat-dissipating grease composition characterized by comprising the following components (A)-(C);
Component (A): 100 mass parts of organopolysiloxane wherein a thixotropicity degree α is 1.03-1.50, a viscosity is 100-1,000,000 mPa·s at 25° C.; in this regard, the thixotropicity degree α is η₁/η₂, herein, η₁ is a measured viscosity at 25° C. measured by a B type rotation viscometer at 6 rpm of a rotor, η₂ is a measured viscosity at 25° C. measured by a B type rotation viscometer at 12 rpm of a rotor.
Component (B): 5-200 mass parts of hydrolysable organopolysiloxane having three functional groups at one end represented by the following general formula (1); 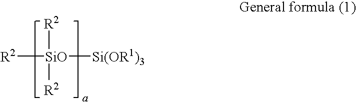
R¹ in the formula is an alkyl group having 1-6 carbon atoms, R² is at least one kind of groups having 1-18 carbon atoms selected from groups consisting of substituted or unsubstituted monovalent hydrocarbon groups, a is an integer of 5-120.
Component (C): 200-4,000 mass parts of a thermoconductive inorganic filler having an average particle diameter of 0.1-100 μm and 0.01-50 m²/g of a specific surface.

2. A heat-dissipating grease composition described in claim 1 wherein the organopolysiloxane of the above component (A) is the organopolysiloxane obtained by reacting an organopolysiloxane having at least two alkenyl groups directly bonded to silicon atoms within a molecule with an organohydrogenopolysiloxane having at least two Si—H groups within a molecule represented by the following 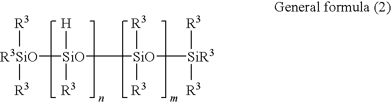
R³ in the general formula (2) is a hydrogen atom, or at least one kind of groups having 1-20 carbon atoms selected from groups consisting of substituted or unsubstituted monovalent hydrocarbon groups except for unsaturated hydrocarbon groups, n and m are respectively numbers which lie within the ranges 1≦n≦1,000 and 0≦m≦1,000.

3. A heat-dissipating grease composition described in claim 2 wherein the organopolysiloxane of the above component (A) contains [R⁴SiO_{3/2}] unit and/or [SiO_{4/2}] unit as well as [R⁴₃SiO_{1/2}] unit and [R⁴₂SiO] unit; in this regard, the above R⁴ is the same as the above R³.

4. A heat-dissipating grease composition described in any of claim 1 wherein a value of a thermoconductive inorganic filler of the above component (C), which is calculated by dividing the surface area represented by [specific area×mass of component (C)] with mass of hydrolysable organopolysiloxane of the above component (B), is within the range of 10-500 m²/g.

5. A heat-dissipating grease composition described in any of claim 2 wherein a value of a thermoconductive inorganic filler of the above component (C), which is calculated by dividing the surface area represented by [specific area×mass of component (C)] with mass of hydrolysable organopolysiloxane of the above component (B), is within the range of 10-500 m²/g.

6. A heat-dissipating grease composition described in any of claim 3 wherein a value of a thermoconductive inorganic filler of the above component (C), which is calculated by dividing the surface area represented by [specific area×mass of component (C)] with mass of hydrolysable organopolysiloxane of the above component (B), is within the range of 10-500 m²/g.
